(19) United States
(12) Patent Application Publication
(10) Pub. No.: US 2026/0264111 A1
(43) Pub. Date: Sep. 10, 2026

(54) CONTINUOUS BELT FOR BELT-TYPE SEPARATOR DEVICES

(71) Applicant: ST Equipment & Technology LLC, Needham, MA (US)

(72) Inventors: Jose L. Rivera-Ortiz, Framingham, MA (US); Lewis Baker, Martborough (GB); Thomas Newman, Brighton, MA (US); David Schaefer, Sudbury, MA (US)

(21) Appl. No.: 19/164,470

(22) PCT Filed: Mar. 15, 2024
(86) PCT No.: PCT/US2024/020205

§ 371 Date: Sep. 11, 2025

Related U.S. Application Data
(60) Provisional application No. 63/452,614, filed on Mar. 16, 2023.

(51) Int. Cl. B07B 1/10

(52) U.S. Cl. CPC B07B 1/10; B07B 2220/00

(57) ABSTRACT

Improved continuous belts for use in belt separator systems for separating components of a material are disclosed. Related belt separator systems and methods of separating components of a material are also disclosed.

### BACKGROUND

### Field of Invention

The present invention relates to a belt with non-rectangular openings that may be used in a belt separation apparatus to separate a particle mixture based on tribo-electric charging of the particles.

### Discussion of Related Art

Belt separator systems (BSS) are used to separate the constituents of particle mixtures based on the charging of the different constituents by surface contact (i.e. the triboelectric effect). FIG. 1 shows a belt separator system 10 such as is disclosed in commonly-owned U.S. Pat. Nos. 4,839,032 and 4,874,507, which are hereby incorporated herein by reference in their entirety for all purposes. One embodiment of belt separator system 10 includes parallel spaced electrodes 12 and 14/16 arranged in a longitudinal direction to define a longitudinal centerline 18, and a belt 20 traveling in the longitudinal direction between the spaced electrodes, parallel to the longitudinal centerline. The belt 20 forms a continuous loop which is driven by a pair of end rollers 22, 24. A particle mixture is loaded onto the belt 20 at a feed area 26 between electrodes 14 and 16. Belt 20 includes counter-current traveling belt segments 28 and 30 moving in opposite directions for transporting the constituents of the particle mixture along the lengths of the electrodes 12 and 14/16. The only moving part of the BSS is the belt 20. The belt is therefore a critical component of the BSS. The belt 20 moves at a high speed, for example, about 40 miles an hour, in an extremely abrasive environment. The two belt segments 28, 30 move in opposite directions, parallel to centerline 18, and thus if they come into contact, the relative velocity is about 80 miles an hour.

Related art belts were previously woven of abrasion resistant monofilament materials. These belts were quite expensive and lasted only about 5 hours. The mode of failure was typically longitudinal wear stripes due to longitudinal wrinkling, that would wear longitudinal holes in the belt such that it would fall apart and catch on itself. The strands would also wear where they crossed and flexed in moving through the separator. The Applicant has made attempts to improve such belts with different materials and different weaves in an attempt to find a woven material with a longer life. These attempts were unsuccessful.

An improvement over woven belts for BSS were belts made by extrusion, which have better wear resistance than woven belts and may last on the order of about 20 hours in a BSS. An example of such extruded belts is described in commonly-owned U.S. Pat. No. 5,819,946 entitled “Separation System Belt Construction,” which is also hereby incorporated herein by reference in its entirety for all purposes. Referring to FIG. 2, there is illustrated a schematic drawing of a section of an extruded belt 40. Control of the geometry of extruded belts is desirable, but can be difficult to achieve with extruded belts.

### SUMMARY

In accordance with one or more aspects, a continuous belt for use in a belt separator system for separating components of a material is disclosed. The belt may comprise longitudinal edge strands of a predefined width, and an array of non-rectangular openings interior to the longitudinal edge strands of the belt, the non-rectangular openings configured to be permeable to the components of the material along the longitudinal direction of the belt.

In accordance with one or more aspects, a method of making a continuous belt for use in a belt separator system for separating components of a material is disclosed. The method may comprise forming a continuous belt with impermeable longitudinal edge strands of a predefined width, and forming an array of non-rectangular openings interior to the longitudinal edge strands of the belt that are configured to be permeable to the components material and for conveying components of the material along the longitudinal direction of the belt.

In accordance with one or more aspects, a belt separator system for separating components of a material is disclosed. The system may comprise a first electrode and a second electrode arranged on opposite sides of a longitudinal centerline and configured to provide an electric field between the first and second electrodes, and a continuous belt having impermeable longitudinal edge strands of a predefined width and non-rectangular openings interior to the longitudinal edge strands that are permeable to the components of the material, the belt configured for conveying components of the material having like net influenceability to the electric field in respective counter-current streams along the longitudinal direction of the continuous belt.

In accordance with one or more aspects, a method of separating components of a material which are admitted into a separation chamber having an elongated dimension, the elongated dimension being long compared to a spacing between a pair of opposing electrode surfaces is disclosed. The method may comprise, providing an electric field being between the opposing electrode surfaces, conveying the components of the material in two streams in opposite directions between the opposing electrode surfaces with a continuous belt having impermeable longitudinal edges of a predefined width and non-rectangular openings interior to the impermeable longitudinal edges that are permeable to the components of the material, and creating multiple particle concentration zones along the length of the belt.

In accordance with one or more aspects, a method of separating different components of a material in a separation chamber is disclosed. The method may comprise steps of admitting the material into the separation chamber, the separation chamber having confronting first and second electrode surfaces spaced more closely than respective lengths of the confronting surfaces, impressing a separation influence toward at least one of the confronting electrode surfaces of the separation chamber, moving the components of like net influenceability of the material near each other in streams moving transversely to the separation influence along the longitudinal direction between the first and second electrode surfaces, the streams being in communication parallel to the separation influence so as to transfer a portion of at least one of the streams to another of the streams by virtue of the continued action of the separation influence as the streams progress transversely to the separation influence so as to separate the different components of the material in the direction of the separation influence according to their relative influenceability to the separation influence, and removing separated streams of the material from said separation chamber. The streams of the material may be mechanically moved by a continuous belt having impermeable longitudinal edge strands of a predefined width and non-rectangular openings interior to the longitudinal edge strands that are permeable to the components of the material to create multiple particle concentration zones along a length of the belt.

In some aspects of any of the above continuous belts, as well as related systems and methods, the openings are triangular in shape. The triangle patterns may be flipped 180 degrees in length across a width of the belt so as to create a repeating pattern of triangular pairs creating a row of triangular pair patterns, and wherein the triangular pairs have no longitudinal strands between the triangles and interior to the longitudinal stands along the edges of the belt.

In some aspects, the repeating triangular pair pattern is mirrored for each row of openings along a length of the belt.

In some aspects, the triangular openings are right triangular or isosceles triangular in shape.

In some aspects, the triangular openings are mirrored along a common edge to create triangle pairs across a width of the belt and the triangle pairs are mirrored across a width of the belt with a longitudinal strand therebetween to create an alternating mirrored triangular pair pattern

In some aspects, the alternating triangular pair pattern with a rectangular strand therebetween is repeated in rows of triangular openings along a length of the belt.

In some aspects, the alternating triangular pair pattern with a rectangular strand therebetween is mirrored in rows of triangular openings along a length of the belt.

In some aspects, an angle of a first and second side of the triangular opening is in a range of 30 degrees to 60 degrees. In some specific aspects, an angle of a first and second side of the triangular opening is in a range of 45 degrees to 60 degrees. In some specific non-limiting aspects, an angle of a first and second side of the triangular opening is 60 degrees.

In some aspects, the continuous belts as well as related systems and methods may further comprise periodic notches formed in the longitudinal edges of the continuous belt at periodic locations in the edges of the continuous belt, the periodic notches being configured for conveying the components of the difficult-to-fluidize material in a direction along the longitudinal direction of the continuous belt so that the components are moved away from edges of the belt separation system.

In some aspects, the periodic notches may have a beveled leading edge. In other aspects, the periodic notches may have a triangular-shape.

In some aspects of the continuous belts as well as related systems and methods, the non-rectangular openings may have dimensions selected to maximize a throughput of a belt separator system. The non-rectangular openings may have dimensions selected to minimize frictional heating of the belt. The non-rectangular openings may have dimensions selected to maximize an operating lifetime of the belt.

In some aspects of the continuous belts, as well as related systems and methods, the non-rectangular openings may have a leading deflective edge. In some aspects, a leading edge of the non-rectangular openings may have an angle in a range from about 25 degrees to about 65 degrees, e.g. about 30 degrees to about 60 degrees, with respect to the longitudinal edge.

In some aspects, the non-rectangular openings may define an open area of the continuous belt in the range of about 35% to about 55%.

In some aspects, the non-rectangular openings may have a depth consistent with belt thickness.

In some aspects, the non-rectangular openings may have a dimension of about 0.35 inch to about 0.5 inch in a direction parallel and/or perpendicular to a belt travel direction.

In some aspects, the non-rectangular openings may be configured to be permeable to the components of the material along the longitudinal direction of the belt and across a width of the belt to create multiple particle concentration zones.

In some aspects, the non-rectangular openings interior to the longitudinal edge strands of the continuous belt may be configured to be permeable to the components of feed material, the non-rectangular openings further being configured for conveying components of the feed material along the longitudinal direction of the continuous belt and across a width of the belt to create multiple particle concentration zones.

### BRIEF DESCRIPTION OF THE DRAWINGS

The foregoing and other advantages of the application will be more fully appreciated with reference to the following drawings in which:

FIG. 1 illustrates a diagram of one example of a belt separator system (BSS);

FIG. 2 illustrates a plan view of an extruded belt with nearly rectangular openings;

FIG. 3 illustrates an enlarged view of a portion of a belt and BSS;

FIG. 4 illustrates an enlarged plan view of a belt with rectangular openings and triangular edge notches;

FIG. 5. illustrates an enlarged plan view of a belt with the openings cut in a continuous angled pattern creating substantially right triangular openings that repeat and the direction of belt travel is indicated by an arrow;

FIG. 6. illustrates an enlarged plan view of a belt with the openings cut in an alternating angled pattern creating substantially right triangular openings that alternate; and

FIG. 7. illustrates an enlarged plan view of a belt with the openings cut in an alternating angled pattern creating substantially equilateral triangular openings that alternate.

### DETAILED DESCRIPTION

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

In accordance with one or more embodiments, various belts used in belt separation apparatus to separate a particle mixture based on tribo-electric charging of the particles are disclosed.

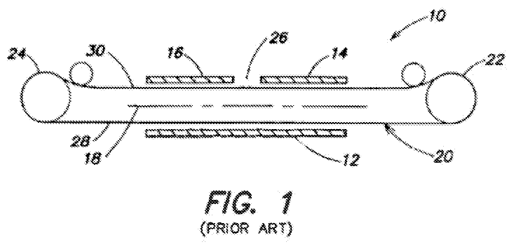

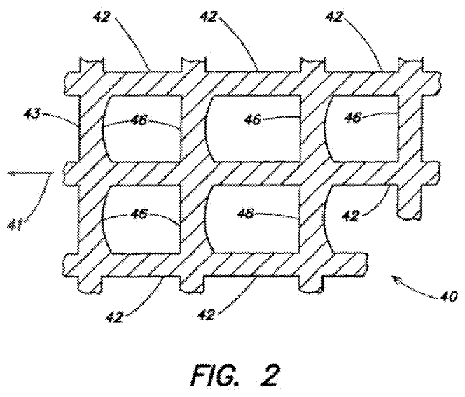

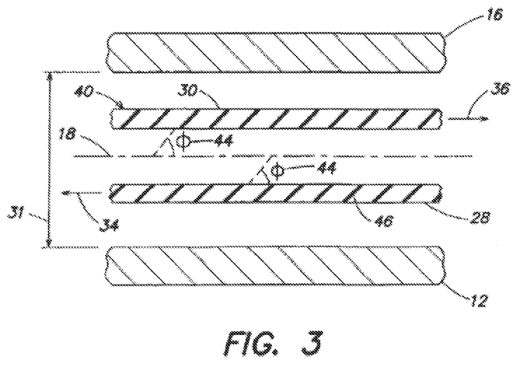

One extruded belt that has been used in BSS is described in commonly-owned U.S. U.S. Pat. No. 5,904,253, which is also hereby incorporated herein by reference in its entirety for all purposes. Referring to FIG. 3, which illustrates an enlarged portion of the BSS shown in FIG. 1, the directions of the counter-travelling belt segments 28, 30 are shown by arrows 34 and 36, respectively. As illustrated in FIGS. 2-3, one example of a desired belt 40 geometry (See FIG. 3) has a leading edge 43 of the belt 42 (See FIG. 2) of the cross direction strands 46 is provided with an acute angle 44.

To improve the life of the extruded belt and to gain better control of the geometry of the belt profiles discussed in U.S. Pat. No. 5,904,253, a method of joining abrasion resistant thermoplastic sheets as described in commonly-owned U.S. Pat. No. 6,942,752, herein incorporated by reference, has been used to produce belts from abrasion resistant thermoplastic sheets. One example of a convenient method for forming the rectangular holes and leading edge and trailing edge features of a desired geometry in such abrasion resistant thermoplastic sheets is to use a multi-axis machine tool. With this device, a sheet is loaded onto a table and a cutter head is moved across the sheet and each opening in the belt may be cut individually. Through the proper choice of cutting tool, the holes can be cut with leading edge and trailing edge features as desired. It is also to be appreciated that the desired leading edge geometry can be obtained through other forming processes and devices such as molding, punching, machining, water jet cutting, laser cutting, and the like.

A further improvement is discussed in U.S. Pat. Nos. 9,393,573 and 10,092,908, where notches are cut into the edges of the abrasion resistant thermoplastic sheets using the same multi-axis tool used for cutting the rectangular holes with the desired leading edge and trailing edge features. The sheets are then joined to form a continuous loop belt using the method described in U.S. Pat. No. 6,942,752. The embodiment of the BSS with a continuous counter current belt moving between two longitudinal, parallel planar electrodes has inside edges of the separation chamber that are not directly swept by the belt. It is desirable to minimize the area of the un-swept zone of the edges of the separation chamber, since it represents electrode area that is not effective for particle separation. However, it is also typical to leave a gap between the edge of the belt and the inside edge of the separation chamber to prevent the belt from rubbing and wearing against the inside edge of the separation chamber, which could lead to early belt failure. Therefore, the width of the belt is approximately 20 mm narrower than the width of the separation chamber, in order to leave about 10 mm clearance between the inside wall of the separation chamber and the edges of the belt.

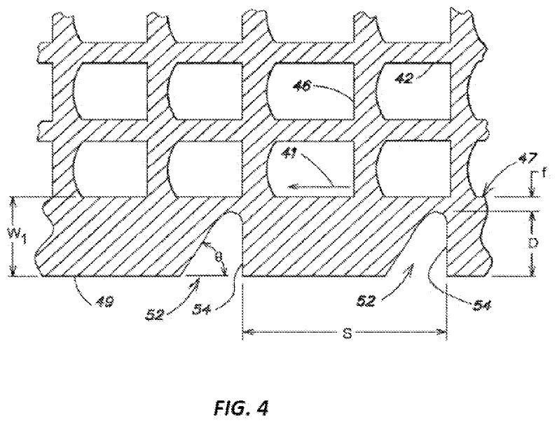

A separator belt with these edge notch features as shown in FIG. 4 is effective at sweeping cohesive, or difficult to fluidize, particles from the un-swept edges of the BSS separation chamber. The addition of the edge notch feature is critical in processing cohesive, difficult to fluidize, powders such as industrial minerals. The use of the BSS belts with the edge notch feature results in a significant increase in operational lifetime of the belt when processing cohesive difficult to fluidize powders, when compared to BSS belts without the edge notch feature. All prior versions of BSS belts have utilized openings that are substantially rectangular, with the exception of the notches cut into the belt edge.

The design and construction of the separator belt is a key feature in the performance of the BSS. The separator belt provides several functions that enable efficient separation using the BSS.

First, the belt transports material from the feed port to either end of the BSS through the narrow separation chamber in a counter current flow pattern. The feed material must pass though the belt at the feed port, so a belt with high open area is preferred. Feed material is then influenced by the electric field in the separation chamber from the voltage applied to the parallel planar electrodes. Charged particles will tend to migrate toward the electrode with opposite charge. The motion of the continuous loop belt produces counter-current particle flow which conveys the separated particles to either end of the BSS. The details of the counter current particle flow pattern is dependent on the belt speed, the belt thickness, the belt hole geometry, and other factors. For this reason, the BSS separator belt geometry is chosen with many open holes and high open area, in order to allow particles to pass freely across the belt under the influence of the applied electric field and to convey particles separated particles at high rate toward either end of the BSS.

Second, the belt provides the mechanical energy necessary for particle-particle, particle-belt, and particle-electrode collisions, that result in the differential tribo-charging necessary for separation. The high-speed operation of the separator belt loop and the narrow gap between electrodes in the separation chamber all encourage vigorous particle collisions, and efficient tribo-charging, and re-charging, along the entire separator length. Different belt geometries can affect the particle collision rates and therefore the efficiency of the separation.

Third, the separator belt is effective at scraping and minimizing detrimental coatings of fine particles on the electrode surface. For separation of non-conductive particles, the presence of thin coatings of electrically insulating powders on the electrode surface hinders the strength of the applied electric field, and therefore is detrimental to efficient separation. Conventional vertical free-fall or drum-type electrostatic separators that do not utilize the BSS separator belts also encounter this problem when processing fine particles. Over the years, various mechanical methods of electrode scraping have been tried. A common method uses a tubular or drum electrode that can rotate against scraper blade devices to remove the tightly adhered fine particles that coat the electrodes (German patent application 1154052B; U.S. Pat. No. 2,187,637). For the BSS separator, the action of the high speed separator belt in the narrow electrode gap and the sharp leading edge of the separator belt cross direction strands combine to be very effective at removing the fine particle coatings that form on the electrodes. In this way, the BSS system is effective in separating mixtures of fine particles without the mechanical and electrical complexity of rotating electrodes.

Prior versions of BSS belts have all utilized a repeating pattern of nearly rectangular openings in the main section of the belt internal to the longitudinal edge strands of belt also referred to as longitudinal edges. The nearly rectangular shape of the openings for prior versions of the BSS belts were chosen by the Applicant to mimic the belt hole pattern and geometry used for belts described in U.S. Pat. No. 5,819,946 that were manufactured using the extrusion process. The openings were nearly rectangular with cross direction strands that are perpendicular to the belt longitudinal direction strands. The trailing edge of the cross direction strand were cut with a minor arc, creating a pattern of repeated nearly rectangular openings in the main section of the belt. The nearly rectangular belt hole pattern and geometry was preferred because it was assumed that it is desirable to move all particles uniformly in the direction of belt travel and minimize movement of particles across the belt width to maintain a uniform particle concentration across the width. Furthermore, it was assumed that cross direction strands that are perpendicular to the direction of belt travel would be more effective at electrode scraping.

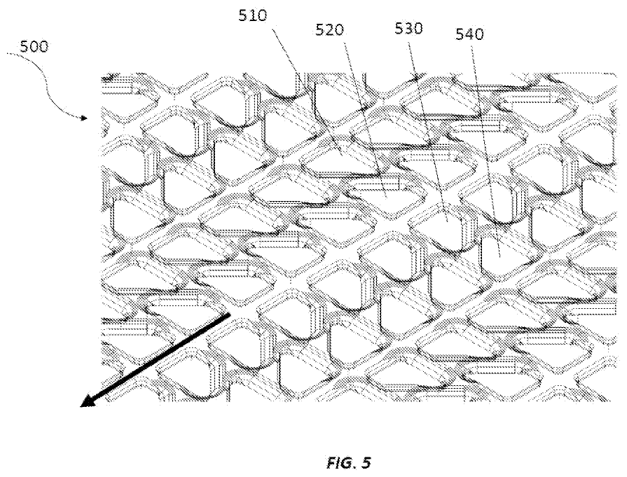

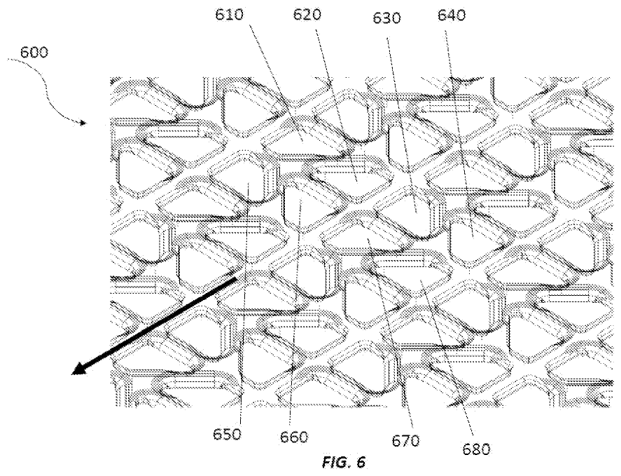

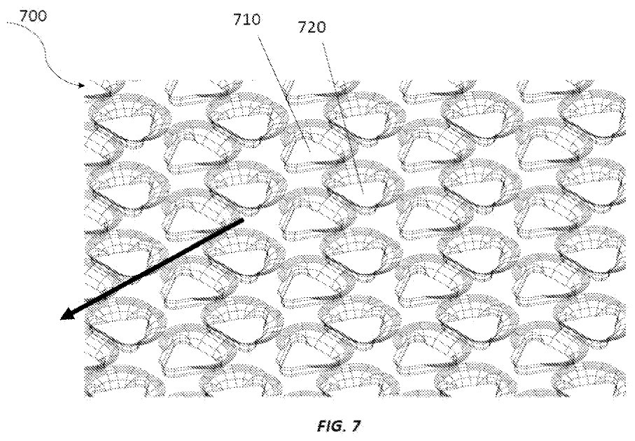

The present disclosure has discovered that a belt with a hole or opening or aperture pattern that includes at least some non-rectangular openings improves the separation efficiency when compared to the standard belt geometry with repeating nearly rectangular openings. According to aspects and embodiments, it is understood that “non-rectangular” includes any shape that is not substantially square or not substantially rectangular, such as illustrated by way of example in any of FIG. 5, FIG. 6 and FIG. 7.

For example, FIG. 5. illustrates an enlarged plan view of a belt 500 with the openings formed in an alternating angled pattern creating substantially right triangular openings that create alternate pairs 510, 520, and the alternate pairs are then mirrored about a longitudinal strand to create a mirrored alternate pair pattern 530, 540 that repeats across a width of the belt to create a row of mirrored alternate pair patterns. The row of mirrored alternate pair patterns are then duplicated to create additional rows along a length of the belt. It has been discovered that a moving belt with triangular openings as shown in FIG. 5 creates counter current particle flow and concentration fields that are not symmetric across the belt width. The angled strands encourage particle motion both in the direction of belt travel and in the direction across the belt width. Therefore, according to aspects and embodiments of this disclosure, the forming and use of belts with non-rectangular openings in the BSS will create regions in the separation chamber of higher particle concentrations and regions with lower particle concentrations across the width of the separation chamber. Movement of some particles in a direction other than the direction of belt travel also increases the residence time of the particle in the separation chamber, and increases the frequency of particle-particle collisions, which can enhance differential tribo-charging in the BSS. The use of separator belts with repeating triangular openings, as shown in FIG. 5, separate mineral powders more efficiently than belts with nearly rectangular openings.

By way of another example according to the disclosure, FIG. 6 illustrates an enlarged plan view of a belt 600 with the openings formed in an alternating angled pattern creating substantially right triangular openings that create alternate pairs 610, 620, and the alternate pairs are then mirrored about a longitudinal strand to create a mirrored alternate pair pattern 630, 640 that repeats across a width of the belt to create a row of mirrored alternate pair patterns. The row of mirrored alternate pair patterns 610, 620, 630, 640 is then mirrored to create mirrored pair rows 650, 660, 670, 680 along a length of the belt. As will be discussed with further illustration to the Examples, herein, it has been observed that belts with repeating rows of non-rectangular patterns (FIG. 5), have a higher separation efficiency than belts with mirrored rows pairs of alternating non-rectangular openings, such as for example substantially right triangular openings that alternate as shown in FIG. 6, which have been found to separate mineral powders less efficiently than belts with a regular repeating pattern of substantially right triangular openings (FIG. 5).

In accordance with one or more embodiments, dimensions of the openings defined by the belt may vary. In some specific non-limiting embodiments, such as those consistent with the accompanying examples, the belts may have openings that are approximately 0.35 to 0.5 inches in the direction parallel and perpendicular to the belt travel direction. Belts can be also characterized by the percentage of the total area of the openings divided by the total belt area, openings plus solid regions. The belts tested for these following examples range from about 32% to about 55% open area. Other dimensions outside of this specified range are also envisioned.

The following examples illustrate the benefit of using belts with non-rectangular openings in the BSS:

### Example 1

In one example, a BSS separator test belt was fabricated with triangular openings (FIG. 5). The shape was achieved by cutting the thermoplastic sheets so that an additional angled strand is added to the usual rectangular opening. The additional strand is angled at 45 degrees from the cross direction strand creating belt openings that approximate right triangles. The angled pattern is mirrored in pairs across the belt width, and repeated for row of holes along the belt length loop. The belt was cut so that the leading edge of the each hole is generally square cut, and the trailing or side edges generally angled such that material is generally directed across the belt width.

This test belt, designated N34, was installed on a pilot-scale BSS separator and a series of batch separation tests were performed using a feed sample of milled calcium carbonate-silicate mixture. Calcium carbonate consistently tribo-charges positive relative to silicates which charge negative. The feed sample was fed in the separator at a constant rate using standard BSS separator operating conditions. Two resulting products were collected from each of the two ends of the separator. The silicate concentration of the two products was determined using the x-ray fluorescence test method, and expressed as % SiO2. The mass of the two resulting products was measured to determine the % mass yield of each product.

A similar series of tests was performed using the same feed material but with a conventional BSS separator belt with nearly rectangular openings, designated A7. The feed rate and separator operating conditions were optimized for each belt to identify conditions that yielded a silicate depleted product with the lowest silicate concentration. The comparison of the resultant mass yields of the two products, composition of the feed and the products are shown in Table 1.

TABLE 1
Separation Results using N34 and A7 design BSS belts

| | Standard Nearly |
|---|---|
| N34 Test Belt | Rectangular Belt (A7) |

| | Mass | SiO2 (%) | Mass | SiO2 (%) |
|---|---|---|---|---|
| Feed | 100% | 8.4 | 100% | 8.4 |
| Silicate- | 56% | 14.2 | 76% | 11.4 |
| enriched | | | | |
| Product | | | | |
| Silicate | 44% | 1.9 | 24% | 1.9 |
| depleted | | | | |
| product | | | | |

The higher mass yield achieved for the commercially valuable silicate depleted product shows the benefit of utilizing the N34 test belt with regular right triangular openings compared to the conventional belt with nearly rectangular openings.

### Example 2

In a second example, two other BSS separator test belts were fabricated with right triangular openings like the N34 belt, but the angle of the additional strand was varied. One belt used a more obtuse angle of 60 degrees from the cross direction strand, designated N44. Another belt used a more acute angle of 30 degrees, designated N45. These test belts were installed on a pilot-scale BSS separator and separation performance was tested in the same manner as Example 1. The comparison of the resultant mass yields of the two products, composition of the feed and the products obtained for each test belt is shown in Table 2.

TABLE 2
Effect of additional strand angle

| | N34 Test Belt | | N44 Test Belt | | N45 Test Belt | |
|---|---|---|---|---|---|---|
| | (45 degrees) | | (60 degrees) | | (30 degrees) | |
| | Mass | SiO2 (%) | Mass | SiO2 (%) | Mass | SiO2 (%) |
| Feed | 100% | 8.4 | 100% | 8.2 | 100% | 8.7 |
| Silicate- | 56% | 14.2 | 52% | 14.3 | 71% | 12.3 |
| enriched | | | | | | |
| Product | | | | | | |
| Silicate | 44% | 1.9 | 48% | 1.6 | 29% | 2.0 |
| depleted | | | | | | |
| product | | | | | | |

Comparison of the mass yield achieved for the commercially valuable silicate depleted product, shows the benefit of utilizing the test belt with more obtuse angles over the test belt with more acute angles.

### Example 3

In a third example, a BSS separator test belt was fabricated with right triangular openings like the N34 belt at 45 degrees, but the angle was mirrored for each row of openings along the belt loop length, designated N36 (FIG. 6). This N36 test belts was installed on a pilot-scale BSS separator and separation performance was compared to the N34 test belt where the orientation of the additional 45 degree angled strand was repeated for each row of openings along the belt loop length. The BSS separation testing was conducted in the same manner as Example 1. The comparison of the resultant mass yields of the two products, composition of the feed and the products obtained for each test belt is shown in Table 3.

TABLE 3
Effect of repeating versus alternating
right triangular patterns (N34 vs N36)

| | |
|---|---|
| N34 Test Belt | N36 Test Belt |
| (repeating) | (alternating) |

| | Mass | SiO2 (%) | Mass | SiO2 (%) |
|---|---|---|---|---|
| Feed | 100% | 8.4 | 100% | 8.9 |
| Silicate- | 56% | 14.2 | 67% | 13.2 |
| enriched | | | | |
| Product | | | | |
| Silicate | 44% | 1.9 | 33% | 1.8 |
| depleted | | | | |
| product | | | | |

Comparison of the mass yield achieved for the commercially valuable silicate depleted product, shows the benefit of utilizing the N34 test belt with the regular repeating triangle pattern over the N36 test belt with an alternating triangle opening pattern.

### Example 4

In a fourth example, a BSS separator test belt 700 was fabricated with alternating triangular openings in the shape of equilateral triangles 710, 720, designated N40 (FIG. 7). This N40 test belt was installed on a pilot-scale BSS separator and separation performance was compared to a standard belt with rectangular openings. The BSS separation testing was conducted in the same manner as Example 1. The comparison of the resultant mass yields of the two products, composition of the feed and the products obtained for each test belt is shown in Table 4.

TABLE 4
Separation Results for N40 vs A7 (nearly rectangular)

| | Standard Nearly |
|---|---|
| N40 Test Belt | Rectangular Belt (A7) |

| | Mass | SiO2 (%) | Mass | SiO2 (%) |
|---|---|---|---|---|
| Feed | 100% | 7.1 | 100% | 8.4 |
| Silicate- | 42% | 15.6 | 76% | 11.4 |
| enriched | | | | |
| Product | | | | |
| Silicate | 58% | 1.9 | 24% | 1.9 |
| depleted | | | | |
| product | | | | |

The higher mass yield achieved for the commercially valuable silicate depleted product shows the benefit of utilizing the N40 test belt with alternating equilateral triangular openings compared to the conventional belt with rectangular openings. Furthermore, this example demonstrates that there are multiple non-rectangular belt patterns and geometry that produce BSS separation results that are superior to those achieved with BSS belts with rectangular openings.

Notably, the N40 (Table 4) performed better than the N34 (Table 3) with respect to silica depleted product mass yield.

### Example 5

Table 5 presents a comparison of the percent open area for the various test belts referenced in Examples 1-4.

TABLE 5
Comparison of % open area

| | | | Pattern | |
|---|---|---|---|---|
| | | | along | |
| | | Pattern | length, in | % |
| Belt | | across | direction | open |
| Code | Hole Shape | width | of travel | area |
| A7 | Standard, nearly rectangular | Repeating | Repeating | 54.9% |
| N34 | Right triangular, 45° | mirrored | Repeating | 44.7% |
| N36 | Right triangular, 45° | mirrored | mirrored | 44.7% |
| N40 | Equilateral triangle, 60° | mirrored | mirrored | 32.2% |
| N44 | Right triangular, 60° | mirrored | Repeating | 47.4% |
| N45 | Right triangular, 30° | mirrored | Repeating | 40.1% |

The belts with a percent open area of less than roughly 55% all performed better than the standard, nearly rectangular hole shape (A7). Open area, however is not the only factor contributing to enhanced performance. The N34 test belt performed better than the N36 test belt despite having nearly identical percent open area. This indicates that the specific hole shape and pattern of openings are also important factors.

Having thus described certain embodiments of a continuous belt, method of making the same, a separation system using such belt, and a method of separation, various alterations, modifications and improvements will be apparent to those of ordinary skill in the art. Such alterations, variations and improvements are intended to be within the spirit and scope of the application. Accordingly, the foregoing description is by way of example and is not intended to be limiting. The application is limited only as defined in the following claims and the equivalents thereto.

What is claimed is:

1. A continuous belt for use in a belt separator system for separating components of a material, the belt comprising:
longitudinal edge strands of a predefined width; and
an array of non-rectangular openings interior to the longitudinal edge strands of the belt, the non-rectangular openings configured to be permeable to the components of the material.

2. The continuous belt of claim 1, wherein the array of non-rectangular openings is an array of trapezoidal openings.

3. The continuous belt of claim 2, wherein the trapezoidal openings are flipped 180 degrees in length across a width of the belt so as to create a repeating pattern of trapezoidal pairs creating a row of trapezoidal pair patterns, and wherein the trapezoidal pairs have no longitudinal strands between the trapezoids and interior to the longitudinal strands along the edges of the belt.

4. The continuous belt of claim 3, wherein the repeating trapezoidal pair pattern is mirrored for each row of openings along a length of the belt.

5. The continuous belt of claim 2, wherein the trapezoidal openings are acute trapezoids, obtuse trapezoids or right trapezoids.

6. The continuous belt of claim 2, wherein the trapezoidal openings are mirrored along a common edge to create trapezoid pairs across a width of the belt and the trapezoid pairs are mirrored across a width of the belt with a longitudinal strand therebetween to create an alternating mirrored trapezoid pair pattern.

7. The continuous belt of claim 6, wherein the alternating trapezoidal pair pattern with a rectangular strand therebetween is repeated in rows of triangular openings along a length of the belt.

8. The continuous belt of claim 6, wherein the alternating trapezoidal pair pattern with a rectangular strand therebetween is mirrored in rows of trapezoidal openings along a length of the belt.

9. The continuous belt of claim 1, wherein the array of non-rectangular openings is an array of triangular openings.

10. The continuous belt of claim 9, wherein the triangular openings are flipped 180 degrees in length across a width of the belt so as to create a repeating pattern of triangular pairs creating a row of triangular pair patterns, and wherein the triangular pairs have no longitudinal strands between the triangles and interior to the longitudinal stands along the edges of the belt.

11. The continuous belt of claim 10, wherein the repeating triangular pair pattern is mirrored for each row of openings along a length of the belt.

12. The continuous belt of claim 9, wherein the triangular openings are right triangular, isosceles triangular or equilateral triangular in shape.

13. The continuous belt of claim 9, wherein the triangular openings are mirrored along a common edge to create triangle pairs across a width of the belt and the triangle pairs are mirrored across a width of the belt with a longitudinal strand therebetween to create an alternating mirrored triangular pair pattern.

14. The continuous belt of claim 13, wherein the alternating triangular pair pattern with a rectangular strand therebetween is repeated in rows of triangular openings along a length of the belt.

15. The continuous belt of claim 13, wherein the alternating triangular pair pattern with a rectangular strand therebetween is mirrored in rows of triangular openings along a length of the belt.

16. The continuous belt of any of the preceding claims, wherein an angle of a first and second side of the openings is an acute angle.

17. The continuous belt of claim 16, wherein the angle of the first and second sides of the openings is in a range of 30 degrees to 60 degrees.

18. The continuous belt of claim 17, wherein the angle of the first and second sides of the openings is in a range of 45 degrees to 60 degrees.

19. The continuous belt of claim 18, wherein the angle of the first and second sides of the opening is 60 degrees.

20. The continuous belt of any of the preceding claims, further comprising periodic notches formed in the longitudinal edges of the continuous belt at periodic locations in the edges of the continuous belt, the periodic notches being configured for conveying the components of the difficult-to-fluidize material in a direction along the longitudinal direction of the continuous belt so that the components are moved away from edges of the belt separation system.

21. The continuous belt of claim 20, wherein the periodic notches have a beveled leading edge.

22. The continuous belt of claim 20, wherein the periodic notches have a triangular-shape.

23. The continuous belt of any of the preceding claims, wherein the non-rectangular openings have dimensions selected to maximize a throughput of a belt separator system for the feed material.

24. The continuous belt of any of the preceding claims, wherein the non-rectangular openings have dimensions selected to minimize frictional heating of the belt.

25. The continuous belt of any of the preceding claims, wherein the non-rectangular openings have dimensions selected to maximize an operating lifetime of the belt for the feed material.

26. The continuous belt of any of the preceding claims, wherein the non-rectangular openings have a leading deflective edge.

27. The continuous belt of claim 26, wherein the leading deflective edge of non-rectangular openings has an angle in a range from about 25 degrees to about 65 degrees, e.g. about 30 degrees to about 60 degrees, with respect to the longitudinal edge.

28. The continuous belt of any of the preceding claims, wherein the non-rectangular openings define an open area of the continuous belt in the range of about 35% to about 55%.

29. The continuous belt of any of the preceding claims, wherein the non-rectangular openings have a dimension of about 0.5 inch to about 1.75 inch in a direction parallel and/or perpendicular to a belt travel direction.

30. The continuous belt of claim any of the preceding claims, wherein the non-rectangular openings are configured to be permeable to the components of the material along the longitudinal direction of the belt and across a width of the belt to create multiple particle concentration zones.

31. The continuous belt of any of the preceding claims, wherein the non-rectangular openings interior to the longitudinal edge strands of the continuous belt are configured to be permeable to the components of the feed material, the non-rectangular openings further being configured for conveying components of the feed material along the longitudinal direction of the continuous belt and across a width of the belt to create multiple particle concentration zones.

32. A method of making the continuous belt of any of claims 1-31 for use in a belt separator system for separating components of a material, the method comprising:
forming a continuous belt with impermeable longitudinal edge strands of a predefined width; and
forming an array of non-rectangular openings interior to the longitudinal edge strands of the belt that are configured to be permeable to the components material and for conveying components of the material along the longitudinal direction of the belt.

33. A belt separator system for separating components of a material, the belt separator system comprising:
a first electrode and a second electrode arranged on opposite sides of a longitudinal centerline and configured to provide an electric field between the first and second electrodes; and
the continuous belt of any of claims 1-31 having impermeable longitudinal edge strands of a predefined width and non-rectangular openings interior to the longitudinal edge strands that are permeable to the components of the material, the belt configured for conveying components of the material having like net influenceability to the electric field in respective counter-current streams along the longitudinal direction of the continuous belt.

34. The system of claim 33, wherein the material includes at least one mineral.

35. The system of claim 34, wherein the material comprises calcium carbonate, iron ore, or barite.

36. The system of claim 33, wherein the material comprises fly ash.

37. The system of claim 33, wherein the material is organically derived.

38. The system of claim 37, wherein the material pertains to food or feed.

39. The system of claim 38, wherein the material comprises sunflower meal.

40. A method of separating components of a material which are admitted into a separation chamber having an elongated dimension, the elongated dimension being long compared to a spacing between a pair of opposing electrode surfaces, the method comprising:
providing an electric field being between the opposing electrode surfaces;
conveying the components of the material in two streams in opposite directions between the opposing electrode surfaces with the continuous belt of any of claims 1-31 having impermeable longitudinal edges of a predefined width and non-rectangular openings interior to the impermeable longitudinal edges that are permeable to the components of the material; and
creating multiple particle concentration zones along the length of the belt.

41. The method of claim 40, wherein the material includes at least one mineral.

42. The method of claim 41, wherein the material comprises calcium carbonate, iron ore, or barite.

43. The method of claim 40, wherein the material comprises fly ash.

44. The method of claim 40, wherein the material is organically derived.

45. The method of claim 44, wherein the material pertains to food or feed.

46. The method of claim 45, wherein the material comprises sunflower meal.

47. A method of separating different components of a material in a separation chamber comprising the steps of:
a. admitting the material into the separation chamber, the separation chamber having confronting first and second electrode surfaces spaced more closely than respective lengths of the confronting surfaces;
b. impressing a separation influence toward at least one of the confronting electrode surfaces of the separation chamber;
c. moving the components of like net influenceability of the material near each other in streams moving transversely to the separation influence along the longitudinal direction between the first and second electrode surfaces, the streams being in communication parallel to the separation influence so as to transfer a portion of at least one of the streams to another of the streams by virtue of the continued action of the separation influence as the streams progress transversely to the separation influence so as to separate the different components of the material in the direction of the separation influence according to their relative influenceability to the separation influence; and
d. removing separated streams of the material from said separation chamber;
wherein the streams of the material are mechanically moved by the continuous belt of any of claims 1-31 having impermeable longitudinal edge strands of a predefined width and non-rectangular openings interior to the longitudinal edge strands that are permeable to the components of the material to create multiple particle concentration zones along a length of the belt.
